(19) United States
(12) Patent Application Publication
(10) Pub. No.: US 2017/0213528 A1
(43) Pub. Date: Jul. 27, 2017

(54) TUNING GUIDE

(71) Applicant: BD Performing Arts, Concord, CA (US)

(72) Inventor: John Meehan, Concord, CA (US)

(21) Appl. No.: 15/413,138

(22) Filed: Jan. 23, 2017

Related U.S. Application Data
(60) Provisional application No. 62/281,653, filed on Jan. 21, 2016.

(51) Int. Cl. G10D 9/00; G10D 7/10

(52) U.S. Cl. CPC G10D 9/005; G10D 7/10

(57) ABSTRACT

Disclosed is a tuning guide for tuning a brass musical instrument having a tuning slide. The tuning guide includes (1) visual markings provided along one arm of the tuning slide indicating a plurality of tuning positions of the tuning slide and (2) a tuning log for logging a tuning history specific to both the instrument and a particular player of the instrument. The tuning log includes a plurality of tuning records, each tuning record including (i) one or more conditions fields, each conditions field for recording an environmental condition and (ii) a tuning position field for specifying a tuning position at which the instrument is properly tuned under the environmental conditions recorded in the one or more conditions fields.

### CROSS-REFERENCE TO RELATED APPLICATIONS

This application claims the benefit of U.S. Provisional Application No. 62/281,653 filed Jan. 21, 2016.

### BACKGROUND

Field of the Invention

This invention relates to musical instruments and particularly to tuning guides for brass musical instruments.

Discussion of the Prior Art

Accurate tuning of brass musical instruments is affected by temperature and humidity and varies according to the embouchure of the performer playing the instrument. Tuning of a brass musical instrument is accomplished by adjusting the length that a tuning slide extends from the instrument and is based on the performer's experience with a particular instrument under similar environmental conditions.

The tuning process generally involves placing an electronic tuner in front of the instrument and then playing a certain note on the instrument. The tuning slide is then pushed in or pulled out of the instrument based on whether the electronic tuner identifies the note played as being sharp or flat. To tune a large ensemble of brass instruments, such as in a marching band, an instructor or conductor typically must repeat this electronic tuning process several times in order to assist each performer in tuning his or her instrument, This can be incredibly time intensive and cumbersome, particularly during travel or in competition, when a brass ensemble must hastily move from one environment to another.

### BRIEF DESCRIPTION OF THE DRAWINGS

FIG. 1 is a schematic representation of a tuning guide according to the invention.

### DETAILED DESCRIPTION OF THE ILLUSTRATED EMBODIMENT

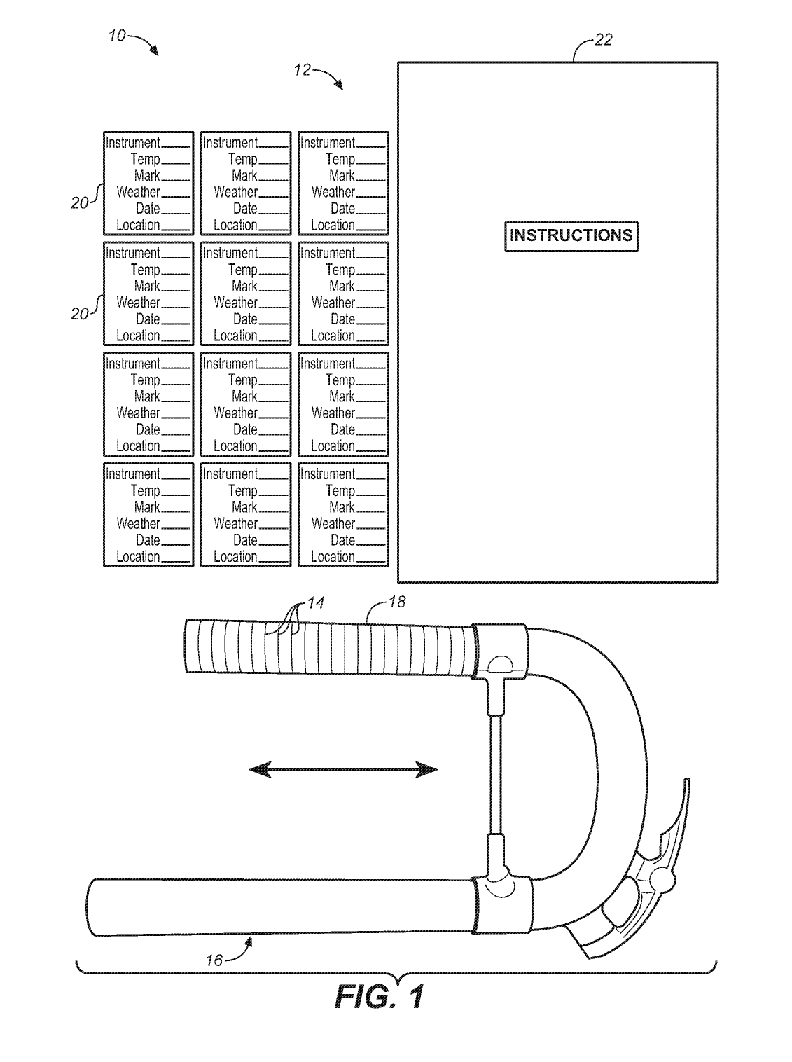

A tuning guide for a brass instrument, referred to generally at numeral 10 in FIG. 1, comprises a tuning log 12 and tuning marks 14 provided along one arm 18 of the tuning slide 16 of a brass instrument, usually at ⅛″ intervals.

If the tuning slide 16 is fully inserted into the instrument and then pulled out, the first mark seen is generally understood to be mark “1,” the second, mark “2,” and so forth. In the illustrated embodiment, there are 21 marks, not counting the end of the arm, however the total number of marks will vary depending on the instrument.

The tuning log 12 comprises a plurality of tuning records 20 and a set of instructions 22 on how to use the tuning guide. Each record 20 contains a space for entering data regarding (1) the instrument being tuned, (2) the ambient temperature when the instrument is tuned, (3) the mark showing on the tuning slide 16 at which the instrument is found to be properly tuned, (4) the weather when the instrument is tuned, (5) the date, and (6) the location. In one embodiment, information identifying the instrument is entered a single time at the top of the tuning record 12 rather than multiple times in each of the individual records. In another embodiment, a space is provided for entering the humidity instead of or in addition to the weather.

Records 20 are used to accumulate a tuning history of what mark 14 the tuning slide 16 is set at when the instrument is tuned under particular temperature and weather, particularly humidity, conditions. For example, at 72° F. with 40% humidity, the tuning slide 16 on a trumpet could be set at mark 4. However, among a group of performing musicians, such as in a marching band, the tuning slide 16 for one performer may be set at a different mark than it is set for another performer. This may be due to differences in musicians' embouchures and to differences between the particular instruments being played. If the humidity were to change from 40% to 80%, assuming the same temperature, the tuning slides will need to be adjusted for each instrument.

By recording the temperature and humidity, or other environmental conditions, existing on multiple incidents when the instrument is tuned, a unique historical tuning record is thus collected for each musician with respect to a particular instrument played by that musician. This historical record can save valuable time when it is necessary to tune all the instruments in an ensemble because the tuning slide 16 can be set at a particular mark 14 at which it was previously set when the same environmental conditions were experienced by making reference to the historical record. If the precise conditions occurring at the time the instrument is being tuned are not found in the historical record, the correct position of the tuning slide 16 can be estimated based on the most closely similar conditions noted in the historical record.

The tuning slide 16 will tune the instrument when pulled out until the desired mark 14 shows. The instrument can also be fine-tuned to a position between two adjacent marks, e.g., mark 2.5, by pulling the tuning slide 16 out to the larger of the two adjacent marks and then pushing the tuning slide 16 back in to the desired fractional mark as shown by the arrows in FIG. 1. For example, if it is desired to tune the instrument by moving the tuning guide 16 to the 2.5 mark, the tuning guide 16 should be pulled out to mark 3 and then pushed back in to the 2.5 position.

A tuning guide 10 can save a considerable amount of time when it is necessary to tune all the instruments in a brass ensemble, such as a marching band. Instead of each instrument being individually tuned, perhaps in reference to an electronic tuner, all the instruments in the ensemble can be tuned quickly and accurately by adjusting the tuning slide 16 to the mark 14 as shown in each tuning record 20 for the same or similar environmental conditions.

Another advantage to the invention is that an instrument, or all the instruments in an ensemble, can be “pre-tuned” for a particular environment while being in another environment. For example, if an ensemble is outside a venue where the temperature is 88° F. with 70% humidity, but will shortly be performing in the venue where the temperature is 72° F. and 40% humidity, the tuning slides 16 can be set at the appropriate mark 14 for the venue rather than tuning the instruments outside and then finding it necessary to retune the instruments once inside the venue.

There have thus been described and illustrated certain embodiments of a tuning guide according to the invention. Although the present invention has been described and illustrated in detail, it should be clearly understood that the disclosure is illustrative only and is not to be taken as limiting.

What we claim is:

1. A tuning guide for tuning a brass musical instrument having a tuning slide, the tuning guide comprising:
a plurality of visual markings provided along one arm of the tuning slide of the brass instrument, said visual markings indicating a plurality of tuning positions of the tuning slide, and
a tuning log for logging a tuning history specific to both the instrument and a particular player of the instrument, said tuning log including a plurality of tuning records, each tuning record including:
(i) one or more conditions fields, each of he conditions fields for recording an environmental condition, and
(ii) a tuning position field for specifying one of said plurality of tuning positions at which the instrument is properly tuned under the environmental conditions recorded in the one or more conditions fields.

2. The tuning guide of claim 1, wherein the plurality of visual markings comprises interval markings spaced at regular intervals along the one arm of the tuning slide.

3. The tuning guide of claim 2, wherein the plurality of visual markings are spaced at ⅛″ intervals.

4. The tuning guide of claim 1, wherein the one or more conditions fields include a temperature field for recording temperature information.

5. The tuning guide of claim 1, wherein the one or more conditions fields include a location field for recording location information.

6. The tuning guide of claim 1, wherein the one or more conditions fields include date or time fields for recording date or timing information.

7. The tuning guide of claim 1, wherein the one or more conditions fields include a weather field for recording weather information.

8. The tuning guide of claim 1, wherein the plurality of visual markings are numerical markings.

9. A method of tuning a brass musical instrument having a tuning slide, the method comprising:
recording in each of a plurality of tuning records collected in a tuning log:
(i) one or more environmental conditions, and
(ii) a tuning position at which the instrument is properly tuned for playing by a particular player of the instrument under the recorded one or more environmental conditions, wherein the tuning position is one position of a plurality of positions of the tuning slide indicated by a plurality of visual markings provided along one arm of the tuning slide.

10. The method of claim 9 further comprising:
selecting one of the tuning records from the tuning log, wherein the selected tuning record includes one or more environmental conditions that approximate the conditions of an environment in which the instrument is to be played, and
tuning the instrument by placing the tuning slide in the tuning position recorded in the selected tuning record.

11. A method of tuning a brass musical instrument having a tuning slide, the method comprising:
selecting one of a plurality of tuning records from a tuning log, wherein the tuning log is for logging a tuning history specific to both the instrument and a particular player of the instrument, each of the plurality of tuning records including one or more environmental conditions fields and a tuning position field, each of the one or ore environmental conditions fields for recording indicia indicating an environmental condition, and the tuning position field for recording indicia indicating a tuning position at which the instrument is properly tuned under the indicated environmental conditions recorded in the one or more environmental conditions fields, and
tuning the instrument by placing the tuning slide in the tuning position recorded in the selected tuning record.
